(19) United States
(12) Patent Application Publication
(10) Pub. No.: US 2011/0180487 A1
(43) Pub. Date: Jul. 28, 2011

(54) Optimized Water Treatment Installation and Process

(75) Inventors: Gildas Manic, Paris (FR); Nicolas David, Torcy (FR); Herve Buisson, Apex, NC (US)

(73) Assignee: VEOLIA WATER SOLUTIONS & TECHNOLOGIES SUPPORT, Saint-Maurice Cedex (FR)

(21) Appl. No.: 13/057,669

(22) PCT Filed: Jul. 27, 2009
(86) PCT No.: PCT/EP09/59683

§ 371 Date: Apr. 6, 2011

(30) Foreign Application Priority Data
Aug. 6, 2008 (FR) 085545

(51) Int. Cl. B01D 37/04; C02F 1/00

(52) U.S. Cl. 210/739; 210/741

(57) ABSTRACT

The invention relates to a process for treating water in an installation comprising a plurality of filtration units, said process comprising at least one step of filtration of said water in said filtration units under initial filtration conditions, and an optional step of modification of the value of at least one controlled parameter within a tolerance interval. According to the inventions, such a process comprises: a step of determining the value of at least one piece of information representative of the clogging capacity of the water to be filtered; a first step of comparing said value of at least one piece of information representative of the clogging capacity with a predetermined threshold value; a step of determining limits of said tolerance interval for said at least one controlled parameter as a function of said first comparison step, said step of determining the value of said at least one piece of information representative of the clogging capacity of the water to be filtered being obtained by making said water to be filtered pass, under conditions different from said initial filtration conditions, through at least one of said filtration units constituting a control filtration unit.

### 1. FIELD OF THE INVENTION

The field of the invention is that of the treatment of water. More specifically, the invention pertains to the treatment of wastewater in filtration units in order to purify it or make it potable.

The invention pertains especially but not exclusively to membrane bioreactors, biological filters (such as Biostyr® commercially distributed by the present Applicant), sand filters and membrane filters (such as filters that can be implemented for reverse osmosis, ultrafiltration, nanofiltration or microfiltration).

### 2. PRIOR ART

Most of the filtration units used for water treatment comprise an open or closed tank that forms a reactor. The water to be treated is introduced into this reactor in order to reduce the pollution therein. The water may for example undergo biological treatment in this reactor.

These filtration units can be constituted by membranes or any other filtering material (sand, polystyrene balls, etc).

When water is being filtered, the solid matter separated from the water is retained by these filtration units. This means, naturally, that that the filtration of water is accompanied by the gradual clogging of the filtration units.

Various technologies can be applied in order to restrict the clogging of the filtration units, for example backwashing or the use of aerators in biological membrane reactors. These aerators, generally positioned beneath the membrane modules, are used to inject a gas (essentially air) preferably intermittently into the reactor. This gas rises in the form of bubbles along the membranes and creates a phenomenon of agitation on their surface that tends to limit their clogging.

### 3. DRAWBACKS OF THE PRIOR ART

However, the clogging of the filtration units, which is not perfectly mastered to date, gives rise to excess production costs which are high enough to constitute a major obstacle to the development of this type of treatment technology.

In particular, the clogging of the filtration units generates an increase in energy requirements. This can be explained by the fact that the clogging of the filtration units is accompanied by an increase in head loss through these units, and this makes it necessary to create a greater depression so that the water to be treated passes through them.

In addition, the filtration units have a life span that is all the more limited as the gradual clogging dictates an increase in the depression needed to make the water pass through them.

This is why it is necessary to inject air to prevent and limit the clogging of the membranes of a membrane bioreactor.

The clogging of the membranes therefore dictates maintenance operations in order to prevent wear and tear in the membranes and restore their retention capacity.

To this end, the filtration phases may be alternated with:
relaxation phases during which the flux through the membranes is stopped;
backwash phases during which the water to be treated is injected in a counter current through the filtration material or membranes.

These phases are aimed at removing the cake of particles that is deposited on the surface of the membranes.

When the implementation of the phases set forth here above is not sufficient and when the clogging of the filtration units becomes excessive, then phases of curative treatment needed to be carried out, for example phases of maintenance cleaning or reagent dipping.

The maintenance of the filtration units then calls for the replacement of the filtration material and the use of relatively abundant manpower and therefore entails fairly high costs.

Techniques have been proposed to overcome this drawback. These techniques concern mainly the treatment of water within membrane bioreactors because these are the most complex and most difficult cases to be resolved.

In particular, the international patent application number WO-A1-2007/006153 describes a water treatment technique aimed at limiting energy expenditure while limiting the clogging of the membranes.

The technique described in the document proposes to control various parameters of a water treatment method as a function of the value of the resistance of the membranes computed during treatment.

The value of the resistance is compared with two threshold values of resistance:
an upper borderline value corresponding to the maximum value of resistance that can be held by the membranes;
a lower borderline value below which the controlled parameters can be made to change in order to achieve energy savings.

When the resistance value measured is greater than the upper borderline value, implying that the clogging of the membranes is excessive, the aeration rate is increased so as to limit the clogging. When the resistance value is below the bottom borderline value, implying that the water treatment is generating little clogging and therefore that the need for aeration of the membranes is low, the aeration rate is reduced so as to obtain energy savings. When the value of the resistance is situated between the upper borderline and the lower borderline, indicating that the system is working properly, the controlled parameters are not modified.

Parameters other than the aeration rate may also be controlled. These are organized hierarchically and are modified iteratively one after the other until a satisfactory performance level is achieved.

A technique of this kind would make it possible, as indicated in this patent application, to significantly reduce the energy consumption needed for the aeration of the membranes. However, this technique has major drawbacks.

In particular, in this technique, firstly the reference values with which the measured resistance value is compared and secondly the instructed or set values of the controlled parameters (for example aeration set value), are determined by experiment in treating a reference water in a typical installation. In other words, these values determined by experiment lead to an optimal exploitation of the membranes implemented in this typical installation during the treatment of water having qualities of the water treated during the development and finalizing of the system. Thus, when treating water with qualities different from that of the water used for developing and finalizing the installation, the performance characteristics of the membranes are not exploited optimally.

In addition, the upper and lower borderline values with which the measured resistances are compared are fixed. Thus, so long as the measured value of the resistance of the membranes is greater than the maximum value, the controlled parameter or parameters are modified in such a way that the clogging of the membranes is limited, implying that the production capacity of the system is limited. In other words, when the quality of the water to be treated is particularly poor, then prevention of the clogging of the membranes will be preferred at the expense of production capacity. This may lead to a situation where the quantity of water produced is below requirements and therefore insufficient.

Besides, this technique works iteratively, i.e. each controlled parameter is modified only if the preliminary modification of the higher parameter in this hierarchy has not led to an improvement in the efficiency of the system. This means that, after the modification of a first parameter, the impact of this modification is evaluated. If the desired performance level is not achieved by this modification of the first parameter, a second parameter must be modified, this operation being repeated until the required performance level is attained. Thus, when the quality of the water to be treated varies swiftly, the modifications made in order to improve the performance of the system exert no real positive impact whatsoever because the system lacks reactivity.

### 4. GOALS OF THE INVENTION

The invention is aimed especially at overcoming these drawbacks of the prior art.

More specifically, it is a goal of the invention to provide a method of water treatment that makes it possible to use the filtration units optimally.

In particular, it is a goal of the invention to provide a technique of this kind that restricts the clogging of the filtration units.

It is also a goal of the invention to implement a technique of this kind that is particularly efficient, including during variations in the quality of the water to be treated.

It is yet another goal of the invention to provide a technique of this kind that makes it possible, in most conditions of exploitation, to produce a sufficient quantity of treated water, i.e. a quantity corresponding to requirements.

### 5. SUMMARY OF THE INVENTION

These goals as well as others that will appear here below are achieved by means of a process for treating water in an installation comprising a plurality of filtration units, the process comprising at least one step for filtering said water in said filtration units under initial filtration conditions, and a step for modifying, if necessary, the value of at least one controlled parameter within a tolerance interval.

According to the invention, such a process comprises:
a step for determining the value of at least one piece of information representing the clogging capacity of the water to be filtered;
a first step for comparing said value of at least one piece of information representing the clogging capacity with a predetermined threshold value;
a step for determining limits of said tolerance interval for said at least one controlled parameter as a function of said first for comparing step,
   said step for determining the value of said at least one piece of information representing the clogging capacity of the water to be filtered being obtained by making said water to be filtered pass, under conditions different from said initial filtration conditions, through at least one of said filtering units constituting a reference filtration unit.

The characteristic according to which the water to be filtered passes into the reference unit under conditions that are different from the initial filtering conditions under which it flows into other filtering units means that the conditions of pressure, flow-rate, duration etc of passage of the water into the reference unit are different from those within the filtration units.

Thus, the invention relies on an original approach to the treatment of water within at least one reactor in which the parameters of the process are controlled and the limits of the tolerance intervals of these parameters are modified according to the clogging capacity of the water to be treated.

If the filtration modules are membrane modules, this aspect of the invention is particularly worthwhile inasmuch as it optimizes the use of the membranes implemented to the utmost, according to the constraints of exploitation. Indeed, determining the clogging capacity of the water to be filtered and accordingly modifying the tolerance interval of the controlled parameter or parameters modifies the controlled parameter or parameters within ranges suited to the treatment of this water by the membranes applied.

This advantage is not got only when implementing membrane modules. On the contrary it can also be got when implementing other types of filtration units such as for example sand filters, biological filters, filters formed by a plurality of balls, for example polystyrene balls, immersed within a column through which the water to be treated passes, units in which the clogging is better controlled and the use of which can be optimized by implementing the invention.

Furthermore, this implementation especially enables the water to be treated to pass in acceleration through a filtration unit similar to the one used to filter water, so as to make it possible anticipate the behavior of the filtration modules during the treatment of water that has just entered the installation. This study then provides for defining the limits of the tolerance intervals of the different controlled parameters so that they are adjusted within ranges of values that make it possible to obtain optimal use of the resources of the filtration modules, given the nature of the water to be treated.

According to one advantageous characteristic of the invention, said step for determining the value of said at least one piece of information representing the clogging capacity of the water to be filtered comprises the following sub-steps:
carrying out successive filtration cycles of said water to be filtered through said reference filtration unit;
continuously measuring the change in pressure or the loss of head through said reference filtration unit during each of said filtration cycles;
varying the value of the flux at which said water passes through said reference filtration unit so that said water passes in each of said filtration cycles at a flux whose value is different from the flux of filtration of said water in at least one previous filtration cycle;
   said one piece of information representing the clogging capacity of the water to be filtered being the value of the flux of circulation of said water recorded during one of said filtration cycles during which said pressure or said loss of head increases beyond a predetermined threshold.

The implementation of these steps is used to define the critical flux, i.e. the flux of water passing through a filtration unit beyond which the clogging of this unit becomes irreversible. The critical flux is an indicator of the clogging capacity of the water to be filtered that is particularly representative and reliable. This technique for determining the critical flux therefore gives a reliable and precise image of the clogging capacity of the water to be filtered.

Advantageously a process according to the invention comprise, for each of the units:
a step for measuring the value of a least one representative piece of information on the resistance of said filtration units;
a step for computing the value of the resistance of said filtration units;
a second step for comparing said computed resistance value with a predetermined threshold resistance value;
a step for modifying, if necessary, said at least one controlled parameter as a function of said second step for comparing.

It may be recalled that the resistance of a filtration unit is equal to the inverse of its permeability. The permeability of a filtration unit is equal to the ratio of the flux of water passing through it to the pressure, the flux being itself equal to the ratio of the filtration flow-rate to the filtration surface area.

The invention therefore relies on the modification of controlled parameters as a function of the value of the resistance of the filtration units. The resistance indeed constitutes an indicator that makes it possible to efficiently follow the progress in time of the clogging of the filtration units.

According to another preferred aspect of the invention, at least two of said parameters are modified simultaneously.

This characteristic ensures that a process according to the invention can be used to efficiently manage the variations in water quality.

According to another advantageous aspect, a treatment process according to the invention comprises a step for modifying said threshold resistance value within a tolerance interval.

It is therefore possible to correct the threshold value of the resistance of the filtration units in order to accept a greater degree of clogging or, on the contrary, to limit the clogging according to circumstances.

In particular, according to yet another advantageous aspect, a process according to the invention comprises a step for choosing the volume of water to be treated in a given period.

The threshold value of resistance can thus be corrected so as to meet the requirements of production of treated water.

In this case, the process advantageously comprises:
a step for measuring the volume of water treated;
a third step for comparing the value of said volume of water treated with said chosen value of the volume of water to be treated in a given period;
a step for possibly correcting said threshold resistance value as a function of said third step for comparing.

This modifies the way in which the controlled parameters are driven so that water can be produced in sufficient quantity. Thus, when the water is not produced in sufficient quantity, the threshold value of resistance can be modified upwardly so as to permit a greater clogging of the membranes. It will then be possible to give priority to the production of water and to produce it so as to meet requirements to the detriment of the filtration units which undergo damage.

According to a preferred characteristic, said at least one controlled parameter is a parameter related to the clogging of said filtration units.

This implementation of the invention therefore leads to obtain mastery over the clogging of the filtration units, at least in greater measure than in the case of the prior-art techniques.

Preferably, said at least one controlled parameter belongs to the group comprising:
the duration of filtration in each of said filtration units;
the flux of filtration in each of said filtration units;
the relaxation time of said filtration units;
the flow-rate of aeration said filtration units;
the duration of aeration of said filtration units;
the quantity of filtration units used;
the activation of a backwash cycle;
the backwashing flow-rate, the backwashing duration, the frequency of backwashing, the volume of water for the backwashing in each of said filtration units;
the conversion rate;
the opening or closing of a circulation return circuit;
the activation of maintenance cleaning of said filtration units;
the activation of curative cleaning of said filtration units.

Acting on at least one of these parameters makes it possible to control the impact of the treatment of water on the clogging of the filtration units.

The present application also pertains to an installation for implementing such a process.

An installation of this type comprises:
a battery of filtration units and means of aeration for said filtration units;
first means for making said water pass through said battery;
means of measuring the resistance of said filtration units;
means of measuring the value of a representative piece of information on the clogging capacity of said water to be filtered;
means of controlling at least one treatment parameter,

Also according to the invention, said means for measuring the value of a representative piece of information of the clogging capacity include at least one filtration unit forming a reference filtration unit that can operate in conditions that are different from said battery and that has the same features as said filtration units forming said battery, and second means for making said water pass through said reference unit.

Advantageously, said filtration units belong to the group comprising:
sand filtration units;
membrane filtration units;
biological filtration units;
polystyrene ball filtration units.

The present technique can therefore be implemented for any type of filtration.

### 6. LIST OF FIGURES

Other features and advantages of the invention shall appear more clearly from the following description of a preferred embodiment given by way of a simple illustrative and non-restrictive example and from the appended figures, of which:

FIG. 1 shows a diagram of an installation according to the invention;

FIG. 2 shows a variant of an installation according to the invention;

FIG. 3 illustrates a diagram of a system for controlling a process according to the invention.

### 7. DESCRIPTION OF ONE EMBODIMENT OF THE INVENTION

### 7.1. Reminder of the General Principle of the Invention

The invention pertains to a process for treating water in a reactor, such as for example a biological membrane reactor, in which at least one parameter such as the rate of aeration of the membranes, the flux through the membranes etc is controlled in such a way that its value can be modified within a range of tolerance. It must be noted that the parameter can for example be modified as a function of the value of the resistance of the membranes measured in real time.

The invention relies on the implementation of a step for measuring a piece of information representing the clogging capacity and a step for comparing this value with a predetermined threshold value so as to effect changes in the limits of the interval of tolerance of the controlled parameter or parameters.

This step for determining the value of a piece of information representing the clogging capacity of the water to be filtered is obtained by causing the water to be treated pass through a reference filtration unit in particular conditions.

This implementation can especially make the water to be treated pass in an accelerated manner through a filtration unit similar to the one used to filter water so as to make it possible to anticipate the behavior of the filtration modules during the treatment of the water that has just entered the installation. This study then allows to define the limits of the tolerance intervals of the different controlled parameters so that they are adjusted within ranges of values that enable the optimal use of the resources of the filtration modules given the nature of the water to be treated.

The implementation of these steps is valuable especially because it enables changes to be made in the ranges of operation of the installation as a function of the quality of water to be treated.

Thus, when the clogging capacity is below a reference value, implying that the quality of the water to be treated is relatively good, the controlled parameters will be capable of evolving within a certain range of values. If it is detected that the clogging capacity of the water to be filtered is greater than a reference value, implying that the quality of the water is deteriorating, then the range within which the controlled parameters are liable to evolve will be modified.

This aspect of the invention is especially valuable inasmuch as it enables the utmost optimizing of the use of the membranes implemented as a function of the exploitation constraints. Indeed, determining the clogging capacity of the water to be filtered and modifying the tolerance interval of the controlled parameter or parameters makes it possible to accordingly modify the controlled parameter or parameters within ranges adapted to the treatment of this water by the membranes that are implemented.

According to another aspect of the invention it is also planned that the threshold value of resistance at which the resistance computed in real time is compared can be modified. In particular, this value could be chosen, from a range of tolerance intervals where the limits will be predetermined, by comparing the flux to be treated over a given period with the flux already treated before the expiry of this period.

Thus, if we consider that 100 m³ of water has to be treated in one day but that, at ¾ of the day, only 50 m³ has been treated, then the threshold value of resistance will be raised so as to enable the production of water in the desired quantities, i.e. in further exploiting the capacities of the membranes. In this case, preference is given to the production to the detriment of the membranes. This clearly counters the current practice of those skilled in the art who, in the prior-art techniques, give preference to preventing the deterioration of the membranes, which in certain cases could lead to not attaining the required level of production of treated water.

According to yet another aspect of the invention, the instructed values of several controlled parameters may vary simultaneously as a function of the value of the resistance of the membranes. This counters the prior-art technique in which the controlled parameters are modified one by one in complying with an order of priority and assessing the impact of each of the modifications until a suitable level of performance is obtained. This characteristic of the invention significantly improves the reactivity of the process in the event of variation of the quality of the water to be treated.

### 7.2. Example of One Embodiment of the Invention

7.2.1. Architecture of a Treatment Installation

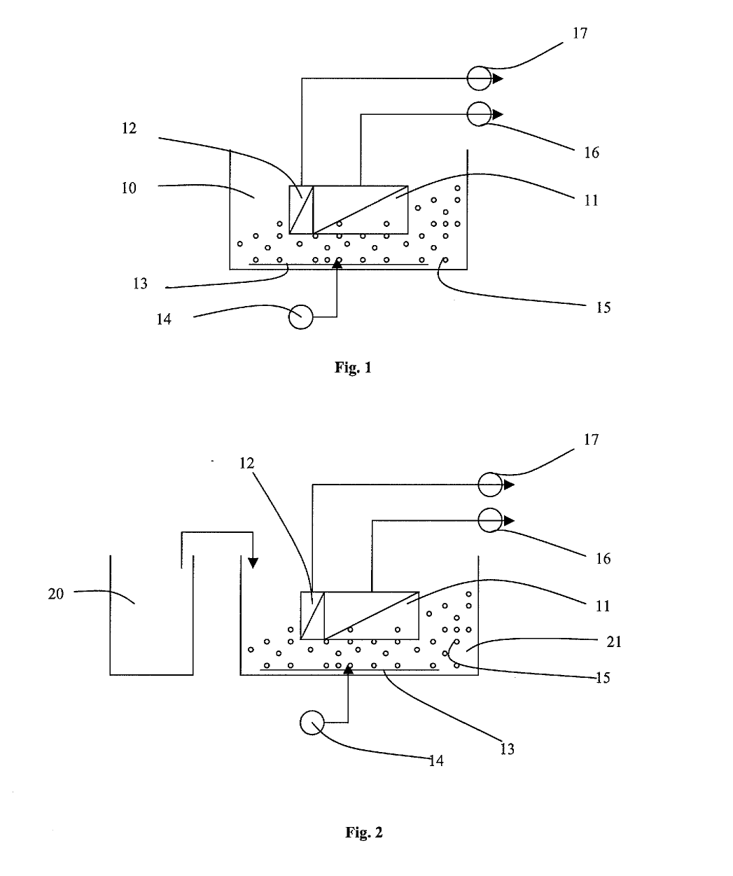

FIG. 1 illustrates a schematic view of an installation intended for implementing a water treatment method according to the invention.

Thus, as can be seen in this figure, such an installation includes a biological reactor 10 containing water to be treated, mixed with activated sludge.

This biological reactor 10 houses a membrane filtration unit 11. This membrane filtration unit 11 may integrate a plurality of membrane modules, for example of the microfiltration, ultrafiltration, nanofiltration, reverse osmosis or other type. These membrane modules may for example include hollow fibers, flat membranes, tubular membranes or membranes of any other type.

The biological reactor 10 also houses a reference membrane module 12. This reference membrane module 12 is identical and has the same characteristics as the modules which form the membrane filtration unit 11.

Aeration means are planned in a lower part of the biological reactor 10. These aeration means may be injection nozzles 13 of gaz, preferably of air. These nozzles are connected to a superchargeur 14.

The air injected into the biological reactor 10 fulfils a function of unclogging and/or preventing the clogging of the filtration membranes. Indeed, the air injected into the biological reactor 10 rises in the form of bubbles 15 along the membranes in such a way that it gives rise to a phenomenon of agitation on their surface. This phenomenon of agitation limits the agglomeration of the activated sludge on the membranes and also removes a part of the deposit accumulated on the surface of the membranes, known as cake.

Another aeration device (not shown) aerates the activated sludge for biological treatment.

The membrane filtration unit 11 is connected to a first variable flow-rate circulation pump 16. The reference membrane module 12 is connected to a second variable flow-rate circulation pump 17.

This installation furthermore comprises a battery or range of sensors (not shown) used to measure different pieces of information on the state of the system. In particular, it has sensors for the measurement, for each of the membrane modules of the filtering unit 11, of the value of the information elements needed to compute their resistance, especially the transmembrane pressure, the flow-rate and the temperature. It also has sensors to measure all the information needed to compute the flux passing through the reference module 12, especially the flow-rate, the transmembrane pressure and the temperature.

FIG. 2 illustrates a variant of an installation according to the invention wherein the first reactor 20 and a second reactor 21 are implemented. The first reactor 20 is a basin of activated sludge while the second reactor 21 houses the membrane modules.

In this embodiment, the filtration modules are membrane modules. In variants, they could of course be filtration units of another type, such as for example sand filters.

This installation also comprises means to control different parameters of the treatment process as a function of the different measurements made.

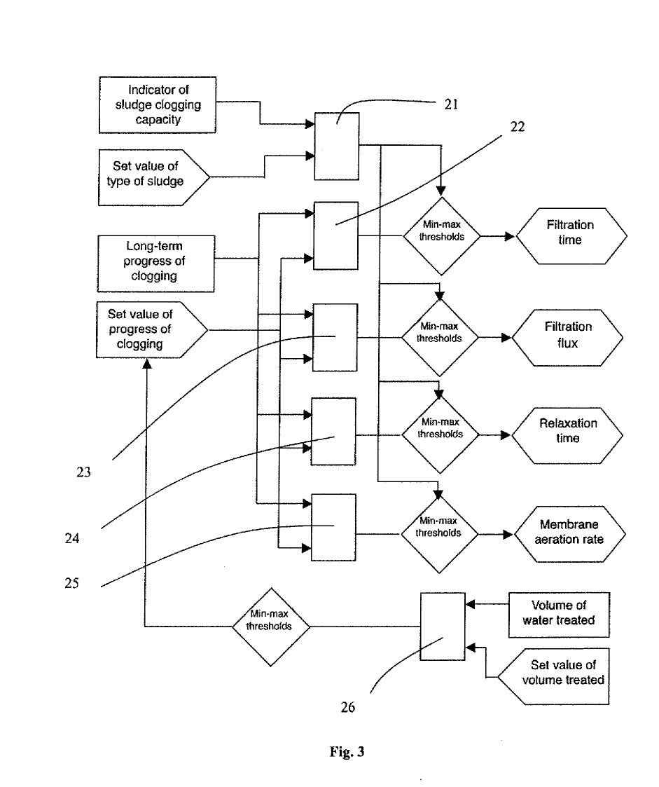

FIG. 3 shows a diagram that illustrates the means for controlling and commanding an installation according to the invention as well as the way in which they interact.

In the present embodiment, the method of the invention enables the control of four parameters:
filtration time;
filtration flux;
relaxation time;
the membrane aeration flow-rate.

However, other parameters may be used such as time and backwashing flow-rate.

In variants of this embodiment, it can also be planned that more than four parameters or less than four parameters are checked. It is also possible to envisage an embodiment in which only one parameter is checked.

The command means herein comprising six controllers (21 to 26). Four of these controllers enable the issuing of a command set value for a controlled parameter in comparing the computed value of the resistance of each of the modules with a predetermined threshold value:
the controller 22 is used to deliver a set value of filtration time;
the controller 23 is used to deliver a set value of filtration flow-rate or flux (the flux being the flow-rate relative to the filtration surface area);
the controller 24 delivers a set value of relaxation time;
the controller 25 is used to deliver a set value of aeration flow-rate.

The controller 21 corrects the tolerance interval in which the set value for each of the controlled parameters delivered by the controllers 22 to 25 must be situated, in comparing a piece of information representing the clogging capacity of the water to be treated with a predetermined threshold value.

The controller 26 is used to correct the threshold value of resistance within an interval for which the bounds are predetermined, in comparing the volume of water treated over a given period with a volume of water that has effectively been treated ever since the start of the treatment.

7.2.2. Calibration of the Installation

A/ Determining Tolerance Intervals for Each Controlled Parameter

The calibration of an installation according to the invention comprises the determining of tolerance intervals for each controlled parameter according to the quality of the water to be treated. Thus, different qualities of water will be allotted different tolerance intervals for each controlled parameter. These tolerance intervals are determined by experience in taking account of the clogging capacity of the water to be filtered which is a parameter representing the quality of the water to be treated.

The determining of the clogging capacity of the water to be treated is done by using the reference module to determine the critical flux, i.e. the flux after which the clogging of the membrane becomes irreversible.

The determining of the critical flux is obtained by making the reference module undergo a succession of filtration cycles, the value of the flux being increased between each cycle, for example through the implementation of a circulation pump with variable flow-rate. The transmembrane pressure is measured continuously during each filtration cycle. This may be achieved for example by means of a manometer. When it is detected that the transmembrane pressure increases beyond a predetermined threshold initially fixed empirically and adjusted case by case, during a filtration cycle, the value of the flux at which the water to be treated is filtered during this cycle is the critical flux.

This protocol for determining the critical flux is only an example. Other methods could be implemented to this end.

In variants, it may be planned to perform, between each filtering cycle, a relaxation phase or backwashing phase so as to restore the membrane. It can also be planned that the flux will not be systematically increased between two consecutive filtration cycles.

When finalizing the method, several experiments are made on the installation so as to treat water of different qualities and determine optimum tolerance intervals for each of them, for each of the parameters controlled. For each trial with water of a particular quality, the set values of each controlled parameter are modified and the impact of these modifications on the clogging of the membranes is assessed so as to determine the operating conditions in which optimal use can be made of the membranes to treat water having these particular qualities.

At the end of the trials for finalizing the installation, each critical flux value tested is allotted a tolerance interval for each of the controlled parameters enabling optimal exploitation of the membranes during the treatment of each type of water.

These trials also make it possible, for each installation, to determine the mean quality of the water that will be conveyed therein for treatment. The quality of the water most frequently encountered during trials, represented by its clogging capacity, will be considered to be the threshold value of clogging capacity.

B/ Determining the Threshold Value of Resistance

As described here above, each controlled parameter may be modified by comparing the resistance computed for each of the membranes with a threshold value.

According to one aspect of the invention, the threshold value of resistance may vary within a tolerance interval whose limits are predefined.

More specifically, the controller 26 is used to correct the threshold value of the resistance by comparing the volume of water to be treated over a given period (for example one day) and the volume of water effectively treated from the beginning of this period (for example from morning). Thus, as and when the day progresses, if the quantity of the water produced does not meet requirements, the controller 26 modifies the threshold value of resistance so as to enable a sufficient production of treated water.

Depending on the results of this comparison, the controller 26 could for example automatically tilt between three treatment modes: careful mode, optimal mode and maximum mode. Each treatment mode has a corresponding value of resistance.

If the quantity of water produced conforms to requirements, the controller 26 will choose to function in optimum mode.

If the quantity of water produced is above requirements, the controller 26 switches into careful mode so as to give preference to the prevention of clogging over the production of treated water.

If on the contrary the water is not produced in sufficient quantities, the controller 26 switches into maximum mode so as to give preference to the production of treated water in taking maximum advantage of the capacities of the membranes.

The controllers 22 to 25 then set up a relationship between the computed resistance and the set value of resistance delivered by the controller 26, and deliver set values for each controlled value.

7.2.3. Implementation of the Process

The implementation of a process according to the invention shall now be described.

During the treatment of the water, the critical flux which represents the clogging capacity of the water is determined as described here above by the use of a succession of filtration phases through the reference module.

The controller 21 then compares the value of the determined critical flux with one or more threshold values so as to modify the limits of the tolerance intervals of each controlled parameter.

At the same time, the measurements made by the different sensors are used to compute the resistance of each membrane.

The controllers 22, 23, 24, 25 respectively, depending on the resistance of each membrane and the set value of resistance related to the operating mode activated by the controller 26, determine the following values:
a set value of filtration time;
a set value of filtration flow-rate;
a set value of relaxation time;
a set value of aeration flow-rate.

These set values are included in the tolerance intervals defined by the controller 21.

If the quality of water deteriorates, i.e. if its clogging capacity increases, the controller 21 modifies the limits of the tolerance intervals of each controlled parameter.

If the set value of one of these parameters is outside its new interval, it is modified accordingly. If not, the set value does not change.

If the modification of the quality of the water has an impact on the computed resistance of each of the membranes, then the controllers 22, 23, 24, 25 will deliver a new set value situated in the new intervals defined by the controller 21.

The operator fixes, for the day, a set value of volume of water to be treated. The volume of water treated from morning is computed during the implementation of the process. If, as and when the day progresses, a comparison made by the controller 26 of the volume to be treated during the day with the volume that has actually passed through since the beginning of the day shows that the system cannot produce sufficient quantities of water, then the controller 26 will modify the set value of resistance. Thus, the capacities of the membranes could be further exploited so as to increase productivity to the detriment of their lifespan.

According to one variant, it can be planned to implement two command horizons. A command horizon known as a “short horizon” could be implemented to track the progress of the clogging. A command horizon known as a “long horizon” could be implemented to track the progress of the volume of water produced. It must be noted that the short and long horizons may be related for example by a multiplier factor type of relationship.

For example, if a filtration cycle is deemed to have a duration of 15 minutes and if the progress of the resistance is computed on 5 to 10 cycles, then this computation will be done in less than three hours. If the short and long horizons are deemed to be related by a multiplier factor of 8, then the tracking of the volume of water will be done in 24 hours.

Now that the general principle of implementation of a process according to the invention has been established, examples of behavior of the regulation shall now be described.

A/ Careful Mode

Table 1 brings collates data on a starting situation called an initial situation.

TABLE 1
Initial values

| | | | Minimum | Maximum |
|---|---|---|---|---|
| Parameters | Value | | threshold | threshold |
| Set value of water type | 40 | L/h/m² | | |
| Set value of daily volume | 100 | m³/j | | |
| Set value of long-term | 4 | m⁻¹/j | | |
| clogging | | | | |
| Measurement of daily volume | 110 | m³/j | | |
| Measurement of critical flux | 40 | L/h/m² | | |
| Measurement of long-term | 3 | m⁻¹/j | | |
| clogging | | | | |
| Filtration time controller 22 | 20 | minutes | 15 | 30 |
| Filtration flux controller 23 | 25 | l/h/m² | 20 | 30 |
| Relaxation time controller 24 | 25 | seconds | 15 | 30 |
| Membrane aeration controller | 10 | Nm³/h/m² | 10 | 15 |
| 25 | | | | |

As indicated in table 1, the set value of the type of water to be filtered, which corresponds to the reference value of the critical flux through the reference module, is set at 40 L/h/m². The daily volume of water that has to be treated is set at 100 m³/j. Finally, the long-term set value of clogging, i.e. of resistance for each of the membranes, is put at 4 m⁻¹/j.

By a computation of long-term clogging of the membranes over several consecutive cycles, it is determined that this clogging is equal to 3 m⁻¹/j. It is therefore below the set value (4 m⁻¹/j).

By a measurement of the daily volume of water to be treated, it is determined that it is equal to 110 m³/j, i.e. that it is higher than the set value.

The initial situation is therefore a situation in which the treatment installation produces more water than necessary without clogging the membranes. The careful mode is then activated by the controller 26 and the controller 21 does not modify the threshold of the different parameters controlled.

B/ Maximum Mode

It is assumed that, in the context of this situation, a pollutant substance reaches the water to be treated. The values corresponding to this situation are collated in table 2.

TABLE 2
Values after pollution peak

| | | | Minimum | Maximum |
|---|---|---|---|---|
| Parameters | Value | | threshold | threshold |
| Set value of water type | 40 | L/h/m² | | |
| Set value of daily volume | 100 | m³/j | | |
| Set value of long-term | 4 | m⁻¹/j | | |
| clogging | | | | |
| Measurement of daily volume | 90 | m³/j | | |
| Measurement of critical flux | 30 | L/h/m² | | |
| Measurement of long-term | 3 | m⁻¹/j | | |
| clogging | | | | |
| Filtration time controller 22 | 20 | minutes | 10 | 25 |
| Filtration flux controller 23 | 25 | l/h/m² | 15 | 25 |
| Relaxation time controller 24 | 25 | seconds | 30 | 35 |
| Membrane aeration controller | 10 | Nm³/h/m² | 20 | 25 |
| 25 | | | | |

The critical flux representing the clogging capacity of the water is now equal to 30 L/h/m². It is therefore lower than the set value, which means that the water has high clogging properties.

It is then necessary to make the configuration of the installation change in order to preserve the membranes.

The controller 21 modifies the tolerance intervals of the different controlled parameters accordingly so that their ranges of evolution are restricted to a field of treatment that is better suited to the water to be treated.

It must be noted that the controllers work classically. They may be for example PID controllers.

The controllers 22 and 23 do not modify the set value that they deliver inasmuch as they are situated in the modified range. By contrast, the controllers 24 and 25 respectively modify the set value that they deliver so that they are situated in the new interval defined by the controller 21.

At the same time, the controller 26 compares the volume of water treated with the volume of water to be treated daily.

The daily volume, whose value is henceforth equal to 90 m³/j, is lower than the set value, i.e. the quantity of water produced is less than needed. The controller 26 activates the maximum mode so as to enable water to be produced in sufficient quantities by making greater use of the capacities of the installation. The controller 26 then delivers a long-term clogging set value known as the maximum value included within the tolerance intervals so as to permit a greater clogging of the membranes, i.e. so as to make greater use of the capacities of the membrane in order to produce sufficient quantities of water.

The controllers 22 to 25, in comparing the measured value of long-term clogging with the set value of long-term clogging delivered by the controller 26, respectively give set values included within the intervals defined by the controller 21 so as to increase the production of treated water.

In this example, the time of filtration and the aeration of the membranes are increased by the controllers 22 and 25 within the limits of their intervals so as to increase the volume of water treated.

C/ Optimal Mode

Once it is detected, by measurement of the critical flux, that the pollution has gone, i.e. that the water is being filtered more efficiently, which is what happens when its clogging capacity (critical flux) becomes equal to the set value of the type of water to be filtered, then the controller 21 again modifies the limits of the tolerance intervals of the different parameters controlled.

The values corresponding to this situation are collated in the following table:

TABLE 3
Values after treatment of the treatment peak

| | | | Minimum | Maximum |
|---|---|---|---|---|
| Parameters | Value | | threshold | threshold |
| Set value of water type | 40 | L/h/m² | | |
| Set value of daily volume | 100 | m³/j | | |
| Set value of long-term | 4 | m⁻¹/j | | |
| clogging | | | | |
| Measurement of daily volume | 100 | m³/j | | |
| Measurement of critical flux | 40 | L/h/m² | | |
| Measurement of long-term | 3 | m⁻¹/j | | |
| clogging | | | | |
| Filtration time controller 22 | 30 (20) | minutes | 15 | 30 |
| Filtration flux controller 23 | 30 (25) | l/h/m² | 20 | 30 |
| Relaxation time controller 24 | 25 | seconds | 15 | 30 |
| Membrane aeration controller | 10 | Nm³/h/m² | 10 | 15 |
| 25 | | | | |

The treated water is henceforth produced in sufficient quantities. The controller 26 then actuates the optimal mode.

If, despite the pollution peak, the long-term clogging at the membranes has not changed, the set values delivered by the controllers 22, 23, 24, 25 will not change (values between brackets). If not, these controllers will deliver set values whose values are included in the intervals defined by the controller 21.

1-9. (canceled)

10. A process for treating water utilizing a plurality of filtering units, comprising:
filtering the water in the plurality of filtering units under initial filtration conditions;
filtering the water in a reference filtration unit under conditions different from the initial filtration conditions;
based on filtering the water in the reference filtration unit, determining the clogging capacity of the water;
comparing the clogging capacity of the water with a clogging capacity threshold or set point value; and
based on comparing the clogging capacity with the clogging capacity threshold or set point value, determining a tolerance range for at least one controlled parameter of the process.

11. The process of claim 10 wherein determining the clogging capacity of the water comprises:
carrying out successive filtration cycles of the water to be filtered through the reference filtration unit;
measuring the change in pressure or the loss of head through the reference filtration unit during each of the filtration cycles; and
varying the value of flux at which the water passes through said reference filtration unit so that the water passes in each of the filtration cycles at a flux whose value is different from the flux of filtration of the water in at least one previous filtration cycle.

12. The process of claim 11 wherein determining the clogging capacity of the water is based in part at least on the flux of the water during one of the filtration cycles during which the pressure or the loss of head increases beyond a predetermined pressure threshold.

13. The process of claim 10 further including:
determining the resistance of the plurality of filtration units;
comparing the determined resistance with a threshold resistance;
based on the comparison of the determined resistance with the threshold resistance, modifying at least one controlled parameter of the process.

14. The process of claim 10 further including modifying at least two controlled parameters or the process simultaneously.

15. The process of claim 14 including modifying the threshold resistance within a tolerance range.

16. The process of claim 13 including:
measuring a volume of water treated over a given period;
comparing the volume of water treated over a given period with the volume of water to be treated over a given period;
based on comparing the volume of water treated over a given period with the volume of water to be treated in a given period, adjusting the threshold resistance.

17. The process of claim 10 wherein at least one controlled parameter of the process is a parameter relating to the clogging capacity of the filtration units.

18. The process of claim 10 wherein at least one controlled parameter of the process is selected from the group comprising:
the duration of the filtration in each of said filtration units;
the filtration flux in each of said filtration units;
the relaxation time of each of said filtration units;
the aeration flow rate of each of said filtration units;
the duration of the aeration of each of said filtration units;
the quantity of filtration units used;
the activation of a backwash cycle;
the backwash flow rate, the backwash duration, the frequency of backwash, the volume of water for the backwash in each of said filtration units;
the conversion rate;
the opening or closing of a circulation return circuit;
the activation of maintenance cleaning of said filtration units; and
the activation of curative cleaning of said filtration units.

19. The process of claim 10 wherein the controlled parameter of the process is taken from the group consisting of filtration time, filtration flux, relaxation time, and membrane aeration rate.

20. A process for treating water in a wastewater treatment facility that filters the water and wherein the wastewater treatment facility includes at least a first filtration unit and a reference filtration unit, and wherein one or more process parameters are varied and controlled based on certain filtration conditions, the process comprising:
determining the value of at least one piece of information that is representative of the clogging capacity of the water to be filtered;
determining the value of at least one piece of information that is representative of the clogging capacity of the water to be treated includes filtering the water to be treated in the reference filtration unit and wherein the determined value of the at least one piece of information is based on filtering the water to be treated in the referenced filtration unit;
comparing the value of the at least one piece of information representative of the clogging capacity with a predetermined clogging capacity threshold; and
based on the comparison of the at least one piece of information representative of the clogging capacity with a predetermined clogging capacity threshold, determining a tolerance range for at least one control parameter of the process.

21. The process of claim 20 wherein determining the value of at least one piece of information representative of clogging capacity includes:
carrying out successive filtration cycles of said water to be filtered through the reference filtration unit;
measuring the change in pressure or loss of head through the reference filtration unit during each of the filtration cycles;
varying the value of flux of the water passing through the reference filtration units so that the water passing in each of the filtration cycles produces a flux whose value is different from the flux in at least one previous filtration cycle; and
wherein the piece of information representative of the clogging capacity of the water to be filtered is the value of the flux during one of the filtration cycles where the pressure or loss of head exceeds a predetermined threshold.

22. The process of claim 20 further including:
measuring the value of a second piece of information that is representative of the resistance of the first filtration unit;
computing the value of the resistance of the first filtration unit;
comparing the computed resistance value with a predetermined threshold resistance value; and
modifying at least one control parameter of the process as a function of the step of comparing the computed resistance value with the predetermined threshold resistance value.
